(19) United States
(12) Patent Application Publication
(10) Pub. No.: US 2021/0235546 A1
(43) Pub. Date: Jul. 29, 2021

(54) METHOD OF MANUFACTURING SEMICONDUCTOR DEVICE

(71) Applicant: KOKUSAI ELECTRIC CORPORATION, Tokyo (JP)

(72) Inventors: Hiroyuki YAMADA, Toyama (JP); Kazuhide ASAI, Toyama (JP)

(73) Assignee: KOKUSAI ELECTRIC CORPORATION, Tokyo (JP)

(21) Appl. No.: 17/015,617

(22) Filed: Sep. 9, 2020

(30) Foreign Application Priority Data
Jan. 24, 2020 (JP) 2020-009599

(51) Int. Cl. H05B 1/02; C23C 14/00

(52) U.S. Cl. CPC H05B 1/0233; C23C 14/0042

(57) ABSTRACT

There is provided a technique that includes: (a) processing a substrate by executing a processing program stored in a memory; (b) inspecting and determining whether the processing program is infected with a computer virus; and (c) executing at least one interruption program stored in the memory and configured to interrupt the processing program when the processing program is determined to be infected with the computer virus.

### CROSS-REFERENCE TO RELATED APPLICATION

This application is based upon and claims the benefit of priority from Japanese Patent Application No. 2020-009599, filed on Jan. 24, 2020 the entire contents of which are incorporated herein by reference.

### TECHNICAL FIELD

The present disclosure relates to a method of manufacturing a semiconductor device.

### BACKGROUND

In the related art, a certain substrate processing apparatus used in a semiconductor device manufacturing process is configured to be connected to another apparatus via a network.

### SUMMARY

In a substrate processing apparatus connected to a network, for example, if there is a virus infection from the network, an operation of the apparatus may be impaired and, consequently, a substrate processing throughput may be adversely affected.

Some embodiments of the present disclosure provide a technique capable of improving a substrate processing throughput.

According to an embodiment of the present disclosure, there is provided a technique that includes: (a) processing a substrate by executing a processing program stored in a memory; (b) inspecting and determining whether the processing program is infected with a computer virus; and (c) executing an interruption program stored in the memory and configured to interrupt the processing program when the processing program is determined to be infected with the computer virus.

### BRIEF DESCRIPTION OF DRAWINGS

The accompanying drawings, which are incorporated in and constitute a part of the specification, illustrate embodiments of the present disclosure.

FIG. 1 is a schematic cross-sectional view showing a substrate processing apparatus according to an embodiment of the present disclosure.

FIG. 2 is a schematic configuration diagram showing a substrate processing module that constitutes a substrate processing apparatus according to an embodiment of the present disclosure.

FIG. 3 is a block diagram showing a controller that constitutes a substrate processing apparatus according to an embodiment of the present disclosure.

FIG. 4 is a flowchart showing an outline of a substrate processing process according to an embodiment of the present disclosure.

FIG. 5 is a flowchart up to an execution of an interruption program according to an embodiment of the present disclosure.

FIG. 6 is an explanatory diagram showing an example of types of interruption programs and processing steps according to an embodiment of the present disclosure.

FIG. 7 is an explanatory diagram showing a processing status of a substrate when it is determined that the processing programs according to an embodiment of the present disclosure are infected with a computer virus, and an example of corresponding interruption programs.

FIG. 8 is an explanatory diagram showing a processing status of a substrate when it is determined that processing programs according to an embodiment of the present disclosure are infected with a computer virus, and an example of addition or non-addition of history data to substrate data.

### DETAILED DESCRIPTION

Reference will now be made in detail to various embodiments, examples of which are illustrated in the accompanying drawings. In the following detailed description, numerous specific details are set forth to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

### An Embodiment

An embodiment of the present disclosure will be described below with reference to the drawings.

A substrate processing apparatus exemplified in the following embodiments is used in a semiconductor device manufacturing process, and is configured to perform a predetermined process on a substrate to be processed. Examples of the substrate to be processed include a semiconductor wafer substrate (hereinafter simply referred to as a “wafer”) in which semiconductor integrated circuit devices (semiconductor devices) are built. When the term “wafer” is used herein, it may refer to “a wafer itself” or “a laminated body (an assembly) of a wafer and a predetermined layer or film formed on a surface of the wafer” (that is, the wafer including the predetermined layer or film formed on the surface thereof may be referred to as a “wafer”). When the phrase “a surface of a wafer” is used herein, it may refer to “a surface (exposed surface) of a wafer itself” or “a surface of a predetermined layer or film formed on a wafer,” that is, “an outermost surface of a wafer as a laminated body.” When the term “substrate” is used herein, it may be synonymous with the term “wafer.” Examples of the process performed on the wafer includes a transfer process, a pressurization (depressurization) process, a heating process, a film-forming process, an oxidation process, a diffusion process, a reflow or annealing process for carrier activation or planarization after ion implantation, and the like.

### (1) Configuration of Substrate Processing Apparatus

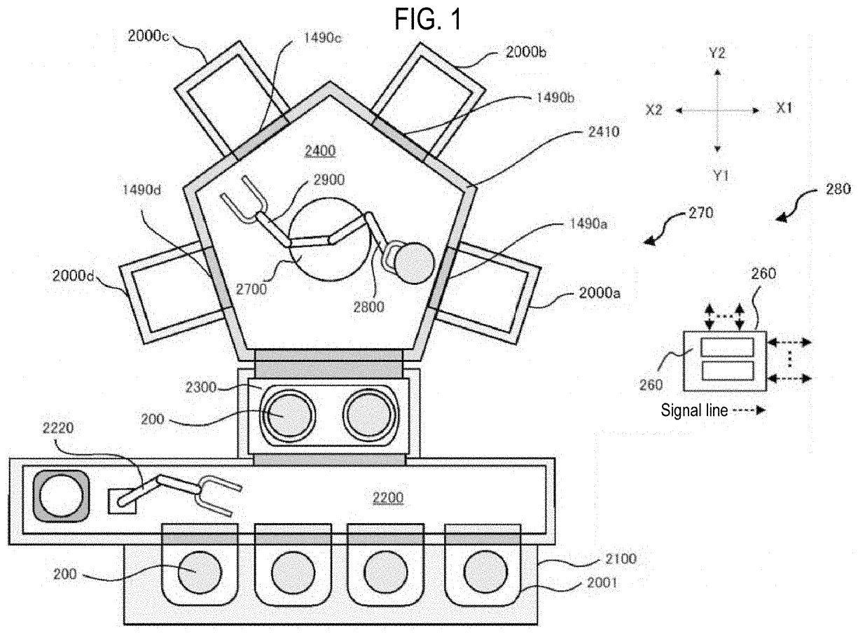

First, a configuration example of a substrate processing apparatus will be described. FIG. 1 is a schematic cross-sectional view showing a substrate processing apparatus according to the present embodiment. The substrate processing apparatus 280 includes a substrate processing unit 270 as a processing part configured to process a wafer 200 as a substrate, and a controller 260 as a control part configured to control the substrate processing unit 270.

As shown in FIG. 1, the substrate processing unit 270 of the substrate processing apparatus 280 according to the present disclosure is configured to process the wafer 200 as the substrate and is of a so-called cluster type including a plurality of substrate processing modules 2000a, 2000b, 2000c and 2000d. More specifically, the cluster type substrate processing unit 270 includes an IO stage 2100, an atmosphere transfer chamber 2200, a load lock (L/L) chamber 2300, a vacuum transfer chamber 2400, and a plurality of substrate processing modules 2000a, 2000b, 2000c and 2000d. Since the substrate processing modules 2000a, 2000b, 2000c and 2000d have the same configuration, they will be generically referred to as a “substrate processing module 2000” in the following description. In the drawings, front, rear, left and right are defined as follows. The X1 direction is right, the X2 direction is left, the Y1 direction is front, and the Y2 direction is rear.

An IO stage (load port) 2100 is provided at the front side of the substrate processing unit 270. On the IO stage 2100, a plurality of storage containers (hereinafter simply referred to as “pods”) 2001 called FOUPs (Front Open Unified Pods) are mounted. The pod 2001 is used as a carrier that transports the wafers 200, and is configured to store a plurality of unprocessed wafers 200 or processed wafers 200 in a horizontal posture.

The IO stage 2100 is adjacent to the atmosphere transfer chamber 2200. In the atmosphere transfer chamber 2200, there is provided an atmosphere transfer robot 2220 as a first transfer robot that transfers the wafer 200. A load lock chamber 2300 is connected to the atmosphere transfer chamber 2200 on a different side from the IO stage 2100.

The load lock chamber 2300 is configured so that an internal pressure thereof is changed according to a pressure in the atmosphere transfer chamber 2200 and a pressure in the vacuum transfer chamber 2400 which will be described below. Therefore, the load lock chamber 2300 is configured to withstand a negative pressure. A vacuum transfer chamber (transfer module: TM) 2400 is connected to the load lock chamber 2300 on a different side from the atmosphere transfer chamber 2200.

The TM 2400 functions as a transfer chamber that is a transfer space in which the wafer 200 is transferred under a negative pressure. A housing 2410 constituting the TM 2400 has a pentagonal shape in a plan view. A plurality of (e.g., four) substrate processing modules 2000 configured to process the wafers 200 are connected to the respective sides of the pentagon except a side to which the load lock chamber 2300 is connected. A vacuum transfer robot 2700 as a second transfer robot that delivers (transfers) the wafers 200 under a negative pressure is provided at a substantially central portion of the TM 2400. Although there is shown an example in which the vacuum transfer chamber 2400 has a pentagonal shape, other polygonal shapes such as a quadrangle, a hexagon and the like may be adopted.

The vacuum transfer robot 2700 provided in the TM 2400 has two arms 2800 and 2900 that can operate independently. The vacuum transfer robot 2700 is controlled by the controller 260 described below.

A gate valve (GV) 1490 is installed between the TM 2400 and each substrate processing module 2000. Specifically, a gate valve 1490a is installed between the substrate processing module 2000a and the TM 2400, and a gate valve 1490b is installed between the substrate processing module 2000b and the TM 2400. A gate valve 1490c is provided between the substrate processing module 2000c and the TM 2400, and a gate valve 1490d is provided between the substrate processing module 2000d and the TM 2400. By opening each gate valve 1490, the vacuum transfer robot 2700 in the TM 2400 can load and unload the wafer 200 via a substrate loading/unloading port 1480 installed at each substrate processing module 2000.

### (2) Configuration of Substrate Processing Module

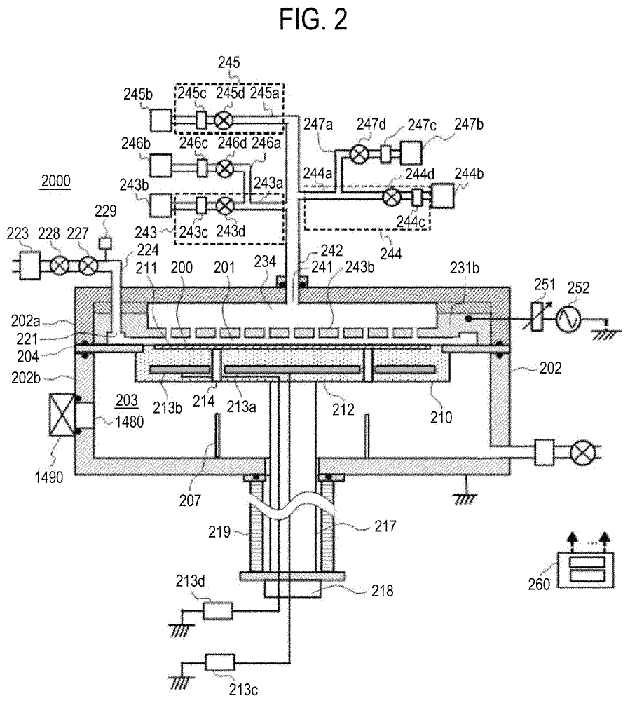

Next, a configuration example of the substrate processing module 2000 of the substrate processing unit 270 will be described. The substrate processing module 2000 executes a substrate processing process which is one of processes of manufacturing a semiconductor device. More specifically, the substrate processing module 2000 performs, for example, a film-forming process as a process for a wafer. In the present embodiment, there is illustrated an example in which the substrate processing module 2000 configured to perform the film-forming process is configured as a single-wafer-type substrate processing apparatus. FIG. 2 is a schematic configuration diagram showing the substrate processing module according to the present embodiment.

### (Processing Container)

As shown in FIG. 2, the substrate processing module 2000 includes a processing container 202. The processing container 202 is made of, for example, a metal material such as aluminum (Al) or stainless steel (SUS), or quartz, and is configured as a flat closed container having a circular cross section. Furthermore, the processing container 202 includes an upper container 202a and a lower container 202b. A partition portion 204 is installed between the upper container 202a and the lower container 202b. A space defined above the partition portion 204 and surrounded by the upper container 202a functions as a processing space (also referred to as a “process chamber”) 201 in which the wafer 200 to be processed in the film-forming process are processed. On the other hand, a space defined below the partition portion 204 and surrounded by the lower container 202b functions as a transfer space (also referred to as “transfer chamber”) 203 configured to transfer the wafer 200. A substrate loading/unloading port 1480 adjacent to the gate valve 1490 is installed at a side surface of the lower container 202b, and the wafer 200 is moved between the transfer chamber 203 and the outside thereof (for example, the TM 2400 adjacent to the transfer chamber 203) via the substrate loading/unloading port 1480. Thus, the space defined below the partition portion 204 and surrounded by the lower container 202b functions as the transfer chamber 203. A plurality of lift pins 207 are installed at a bottom of the lower container 202b. The lower container 202b is grounded.

### (Substrate Support Part)

A substrate support part (susceptor) 210 that supports the wafer 200 is installed at the process chamber 201. The susceptor 210 includes a substrate mounting stand 212 having a substrate mounting surface 211 on which the wafer 200 is mounted. The substrate mounting stand 212 includes at least heaters 213a and 213b built therein and configured to adjust (heat or cool) a temperature of the wafer 200 on the substrate mounting surface 211. Temperature adjustment parts 213c and 213d configured to adjust electric power supplied to the heaters 213a and 213b respectively are connected to the heaters 213a and 213b respectively. The temperature adjustment parts 213c and 213d are independently controlled according to an instruction from a controller 260 described below. Thus, the heaters 213a and 213b are configured to be capable of performing a zone control in which temperature adjustment can be independently performed on a zone-by-zone basis for the wafer 200 on the substrate mounting surface 211. In addition, through-holes 214 through which the lift pins 207 penetrate are formed at the substrate mounting stand 212 at positions corresponding to the lift pins 207.

The substrate mounting stand 212 is supported by a shaft 217. The shaft 217 penetrates a bottom of the processing container 202 and is connected to an elevating mechanism 218 outside the processing container 202. By operating the elevating mechanism 218, the substrate mounting stand 212 can be raised or lowered. A periphery of a lower end portion of the shaft 217 is covered with a bellows 219, and the inside of the process chamber 201 is kept airtight.

When transferring the wafer 200, the substrate mounting stand 212 descends so that the substrate mounting surface 211 is at a position of the substrate loading/unloading port 1480 (wafer transfer position). When processing the wafer 200, the wafer 200 ascends to a processing position (wafer processing position) in the process chamber 201. Specifically, when the substrate mounting stand 212 is lowered to a wafer transfer position, the upper end portions of the lift pins 207 protrude upward from an upper surface of the substrate mounting surface 211, whereby the lift pins 207 can support the wafer 200 from below. Furthermore, when the substrate mounting stand 212 is raised to the wafer processing position, the lift pins 207 are retracted from the upper surface of the substrate mounting surface 211, whereby the substrate mounting surface 211 can support the wafer 200 from below. Since the lift pins 207 make direct contact with the wafer 200, the lift pins 207 may be made of a material such as, for example, quartz or alumina in some embodiments.

### (Gas Introduction Port)

A gas introduction port 241 configured to supply various gases into the process chamber 201 is installed at the top of the process chamber 201. The configuration of the gas supply unit connected to the gas introduction port 241 will be described below.

In the process chamber 201 communicating with the gas introduction port 241, a shower head (buffer chamber) 234 having a distribution plate 234b may be disposed to distribute the gas supplied from the gas introduction port 241 and to evenly diffuse the gas in the process chamber 201.

A matching unit 251 and a high-frequency power source 252 are connected to the support member 231b of the distribution plate 234b, and are configured to be capable of supplying electromagnetic waves (high frequency power or microwaves). Thus, the gas supplied into the process chamber 201 via the distribution plate 234b can be excited into plasma. That is, the distribution plate 234b, the support member 231b, the matching unit 251 and the high-frequency power source 252 convert a first processing gas and a second processing gas, which will be described below, into plasma, and function as a portion of a first gas supply part (details of which will be described below) and a portion of a second gas supply part (details of which will be described below), which supply the plasma-converted gases.

### (Gas Supply Part)

A common gas supply pipe 242 is connected to the gas introduction port 241. A first gas supply pipe 243a, a second gas supply pipe 244a and a third gas supply pipe 245a are connected to the common gas supply pipe 242. A first processing gas (details of which will be described below) is mainly supplied from a first gas supply part 243 including the first gas supply pipe 243a, and a second processing gas (details of which will be described below) is mainly supplied from a second gas supply part 244 including the second gas supply pipe 244a. A purge gas is mainly supplied from a third gas supply part 245 including the third gas supply pipe 245a.

### (First Gas Supply Part)

At the first gas supply pipe 243a, a first gas supply source 243b, a mass flow controller (MFC) 243c, which is a flow rate controller (flow rate control part), and a valve 243d, which is an opening/closing valve, are installed sequentially from the upstream side. A gas containing a first element (first processing gas) is supplied from the first gas supply source 243b to the process chamber 201 through the MFC 243c, the valve 243d, the first gas supply pipe 243a and the common gas supply pipe 242.

The first processing gas is, for example, a gas containing a silicon (Si) element. Specifically, a dichlorosilane (SiH₂Cl₂, dichlorosilane: DCS) gas, a tetraethoxysilane (Si(OC₂H₅)₄, tetraethoxysilane: TEOS) gas, or the like is used. In the following description, an example using a DCS gas will be described.

A downstream end of a first inert gas supply pipe 246a is connected to the first gas supply pipe 243a on the downstream side of the valve 243d. At the first inert gas supply pipe 246a, an inert gas supply source 246b, an MFC 246c and a valve 246d are installed sequentially from the upstream side. An inert gas is supplied from the inert gas supply source 246b to the first gas supply pipe 243a via the MFC 246c and the valve 246d. The inert gas is, for example, a nitrogen (N₂) gas. As the inert gas, a rare gas such as an argon (Ar) gas, a helium (He) gas, a neon (Ne) gas or a xenon (Xe) gas may be used in addition to the N₂ gas.

A first gas supply part (also referred to as Si-containing gas supply part) 243, which is one of processing gas supply parts, is mainly configured by the first gas supply pipe 243a, the MFC 243c and the valve 243d. The first gas supply source 243b may be included in the first gas supply part 243. Further, a first inert gas supply part is mainly configured by the first inert gas supply pipe 246a, the MFC 246c and the valve 246d. The inert gas supply source 246b and the first gas supply pipe 243a may be included in the first inert gas supply part. Further, the first inert gas supply part may be included in the first gas supply part 243.

### (Second Gas Supply Part)

At the second gas supply pipe 244a, a second gas supply source 244b, an MFC 244c and a valve 244d are installed sequentially from the upstream side. A gas containing a second element (second processing gas) is supplied from the second gas supply source 244b to the process chamber 201 via the MFC 244c, the valve 244d, the second gas supply pipe 244a and the common gas supply pipe 242.

The second processing gas contains a second element (e.g., nitrogen) different from the first element (e.g., Si) contained in the first processing gas, and is, for example, a nitrogen (N)-containing gas. As the N-containing gas, for example, an ammonia (NH₃) gas is used.

A downstream end of a second inert gas supply pipe 247a is connected to the second gas supply pipe 244a on the downstream side of the valve 244d. At the second inert gas supply pipe 247a, an inert gas supply source 247b, an MFC 247c and a valve 247d are installed sequentially from the upstream side. An inert gas is supplied from the inert gas supply source 247b to the second gas supply pipe 244a via the MFC 247c and the valve 247d. The inert gas is the same as that supplied from the first inert gas supply part.

A second gas supply part (also referred to as an oxygen-containing gas supply part) 244, which is another one of the processing gas supply parts, is mainly configured by the second gas supply pipe 244a, the MFC 244c and the valve 244d. The second gas supply source 244b may be included in the second gas supply part 244. Further, a second inert gas supply part is mainly configured by the second inert gas supply pipe 247a, the MFC 247c and the valve 247d. The inert gas supply source 247b and the second gas supply pipe 244a may be included in the second inert gas supply part. Moreover, the second inert gas supply part may be included in the second gas supply part 244.

### (Third Gas Supply Part)

At the third gas supply pipe 245a, a third gas supply source 245b, an MFC 245c and a valve 245d are installed sequentially from the upstream side. An inert gas as a purge gas is supplied from the third gas supply source 245b to the process chamber 201 via the MFC 245c, the valve 245d, the third gas supply pipe 245a and the common gas supply pipe 242.

The inert gas is, for example, an N₂ gas. As the inert gas, a rare gas such as an argon (Ar) gas, a helium (He) gas, a neon (Ne) gas or a xenon (Xe) gas may be used, in addition to the N₂ gas.

A third gas supply part (also referred to as a purge gas supply part) 245, which is an inert gas supply part, is mainly configured by the third gas supply pipe 245a, the MFC 245c and the valve 245d. The third gas supply source 245b may be included in the third gas supply part 245.

### (Exhaust Part)

An exhaust port 221 configured to exhaust the atmosphere in the process chamber 201 is installed at the upper surface of the inner wall of the process chamber 201 (upper container 202a). An exhaust pipe 224 as a first exhaust pipe is connected to the exhaust port 221. A pressure regulator 227 such as an APC (Auto Pressure Controller) or the like that controls the pressure in the process chamber 201 to a predetermined pressure, an exhaust regulation valve 228 as an exhaust regulation part installed at a preceding stage or a subsequent stage of the pressure regulator 227, and a vacuum pump 223 are connected to the exhaust pipe 224 in series.

The pressure regulator 227 and the exhaust regulation valve 228 are configured to regulate the pressure in the process chamber 201 according to control of the controller 260 described below when performing the substrate processing process described below. More specifically, the pressure regulator 227 and the exhaust regulation valve 228 are configured so that the pressure in the process chamber 201 is regulated by changing an opening degree of the valve in the pressure regulator 227 and the exhaust regulation valve 228 according to the process recipe in which procedures and conditions of the substrate processing process are described.

Further, at the exhaust pipe 224, for example, a pressure sensor 229 as a pressure measurement part configured to measure the pressure in the exhaust pipe 224 is installed in the preceding stage of the pressure regulator 227 (i.e., on the side close to the process chamber 201). In the present embodiment, there is exemplified the case where the pressure sensor 229 measures the pressure in the exhaust pipe 224. Alternatively, the pressure sensor 229 may measure the pressure in the process chamber 201. In other words, the pressure sensor 229 may be any sensor configured to measure the pressure inside the process chamber 201 or the pressure inside the exhaust pipe 224 that constitutes an exhaust part.

An exhaust part (exhaust line) is mainly configured by the exhaust port 221, the exhaust pipe 224, the pressure regulator 227 and the exhaust regulation valve 228. The vacuum pump 223 and the pressure sensor 229 may be included in the exhaust part.

### (3) Configuration of Controller

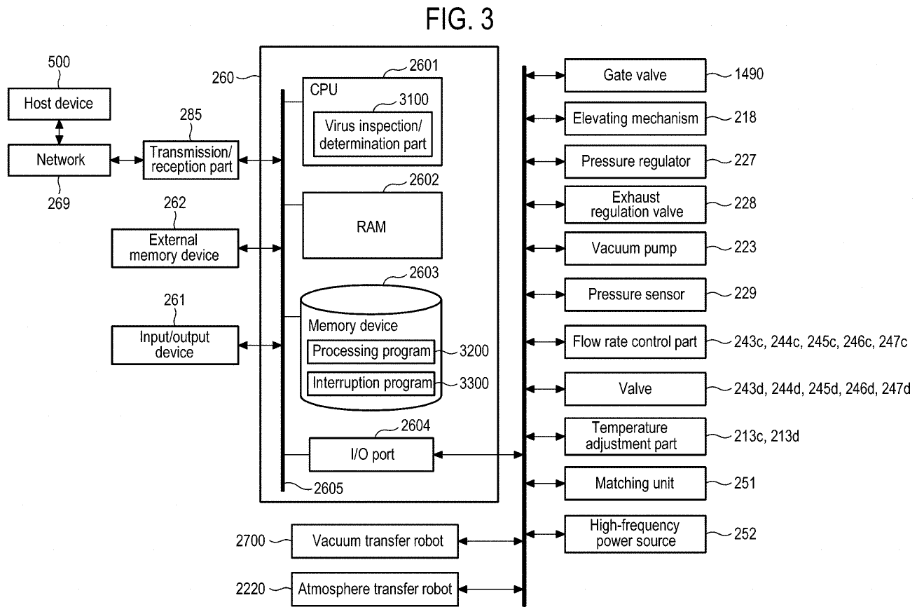

Next, a configuration example of the controller 260 of the substrate processing apparatus 280 will be described. The controller 260 controls the processing operation of the substrate processing unit 270 including the substrate processing module 2000 described above. FIG. 3 is a block diagram showing the controller according to the present embodiment.

### (Hardware Configuration)

The controller 260 functions as a control part (control means) configured to control the operation of the substrate processing unit 270. Therefore, as shown in FIG. 3, the controller 260 is configured as a computer including a CPU (Central Processing Unit) 2601, a RAM (Random Access Memory) 2602, a memory device 2603 and an I/O port 2604. The RAM 2602, the memory device 2603 and the I/O port 2604 are configured to be capable of exchanging data with the CPU 2601 via an internal bus 2605.

The memory device 2603 includes, for example, a flash memory, an HDD (Hard Disk Drive), or the like. A control program that controls the operation of the substrate processing unit 270, a process recipe in which the procedures and conditions of a substrate processing process are described, calculation data or processing data generated in various processing processes, and the like are readably stored in the memory device 2603. The process recipe is combined to cause the controller 260 to execute each procedure of a substrate processing process to obtain a predetermined result. The process recipe functions as a program. That is, the memory device 2603 has a function as a program storage part configured to store the program. In the following description, the control program, the process recipe and the like are collectively referred to as “processing program 3200.” Furthermore, in the memory device 2603, an interruption program 3300 that interrupts execution of the processing program 3200, the details of which will be described below in detail, is also stored in a readable manner. The memory device 2603 also has a function as a table storage part that stores table data described below.

The RAM 2602 is configured as a memory area (work area) in which programs, calculation data, processing data, and the like read by the CPU 2601 are temporarily stored.

The I/O port 2604 is connected to the gate valve 1490, the elevating mechanism 218, the pressure regulator 227, the exhaust regulation valve 228, the vacuum pump 223, the pressure sensor 229, the MFCs 243c, 244c, 245c, 246c and 247c, the valves 243d, 244d, 245d, 246d and 247d, the temperature adjustment parts 213c and 213d, the matching unit 251, the high-frequency power source 252, the vacuum transfer robot 2700, the atmospheric transfer robot 2220, and the like.

Further, the controller 260 is configured so that the input/output device 261 configured as, for example, a touch panel or the like, and the external memory device 262 can be connected to the controller 260. Further, the controller 260 is configured to be connectable to a host device 500 via a transmission/reception part 285 and a network 269. In addition, the controller 260 is configured to be connectable to another substrate processing apparatus, an external recording medium or the like via the transmission/reception part 285 and the network 269. As used herein, the term “connected” includes a meaning that each part is connected by a physical cable (signal line), and also includes a meaning that a signal (electronic data) of each part can be directly or indirectly transmitted/received.

### (Program)

The processing program 3200, the interruption program 3300, and the like stored in the memory device 2603 function as programs executed by the CPU 2601 as an arithmetic part.

The CPU 2601 as the arithmetic part is configured to read a program from the memory device 2603 and execute the same. According to the contents specified by the read program, the CPU 2601 performs the opening/closing operation of the gate valve 1490, the raising/lowering operation of the elevating mechanism 218, the power supply to the temperature adjustment parts 213c and 213d, the power matching operation of the matching unit 251, the on/off control of the high-frequency power source 252, the control of the operations of the MFCs 243c, 244c, 245c, 246c and 247c, the control of the gas supply/cutoff operations of valves 243d, 244d, 245d, 246d, 247d, and 308, the adjustment of the valve opening degree of the pressure regulator 227, the adjustment of the valve opening degree of the exhaust regulation valve 228, the on/off control of the vacuum pump 223, the control of the operation of the vacuum transfer robot 2700, the control of the operation of the atmosphere transfer robot 2220, and the like.

As described above, the controller 260 is configured to be connectable to another substrate processing apparatus, an external recording medium, or the like via the transmission/reception part 285 and the network 269. Therefore, there is a possibility that the processing program 3200 stored in the memory device 2603 is infected with a computer virus (hereinafter sometimes simply referred to as “virus”) from another substrate processing apparatus, the external recording medium, or the like via the network 269. Thus, anti-virus software is used to cause the CPU 2601 to function as a virus inspection/determination part 3100 to inspect and determine whether the processing program 3200 is infected with the virus.

The controller 260 is not limited to being configured as a dedicated computer, but may be configured as a general-purpose computer. For example, the controller 260 according to the present embodiment may be configured by providing an external memory device 262 (e.g., a magnetic tape, a magnetic disk such as a flexible disk, a hard disk or the like, an optical disk such as a CD, a DVD or the like, a magneto-optical disk such as an MO or the like, and a semiconductor memory such as a USB memory, a memory card or the like) 262 that stores the above-described programs, and installing a program in the general-purpose computer using the external memory device 262. However, the means that supplies the program to the computer is not limited to the case of supplying the program via the external memory device 262. For example, the program may be supplied by using other communication means without having to use the external memory device 262. The memory device 2603 and the external memory device 262 are configured as a computer-readable recording medium. Hereinafter, the memory device 2603 and the external memory device 262 are collectively and simply referred to as a recording medium. In the subject specification, when the term “recording medium” is used, it may include only the memory device 2603, only the external memory device 262, or both of them.

### (4) Basic Procedure of Substrate Processing Process

Next, as one of processes of manufacturing a semiconductor device, a substrate processing process of forming a predetermined film on the wafer 200 will be described by way of example. In the present embodiment, a case where a silicon nitride film (SiN film) as a nitride film is formed as the predetermined film will be described by way of example. The substrate processing process described below is performed by the substrate processing unit 270 of the substrate processing apparatus 100 described above. In the following description, the operation of each part is controlled by the controller 260.

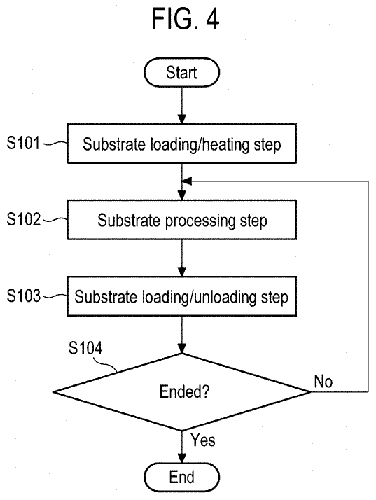

FIG. 4 is a flowchart showing an outline of the substrate processing process according to the present embodiment.

### (Substrate Loading/Heating Step: S101)

In the substrate processing process, first, in the substrate loading/heating step (S101), an unprocessed wafer 200 is taken out from the pod 2001 on the IO stage 2100, and the wafer 200 is loaded into the substrate processing module 2000. When there is a plurality of substrate processing modules 2000, the wafer 200 is loaded into the respective substrate processing modules 2000 in a predetermined order. The wafer 200 is unloaded by using the atmosphere transfer robot 2220 in the atmosphere transfer chamber 2200. The wafer 200 is loaded by using the vacuum transfer robot 2700 in the TM 2400. After the wafer 200 is loaded, the vacuum transfer robot 2700 is retracted, the gate valve 1490 is closed, and the inside of the processing container 202 of the substrate processing module 2000 is sealed. Thereafter, the substrate mounting stand 212 is raised to locate the wafer 200 on the substrate mounting surface 211 at the wafer processing position. In this state, the exhaust part (exhaust system) is controlled so that the inside of the process chamber 201 has a predetermined pressure, and the heaters 213a and 213b are controlled so that the surface temperature of the wafer 200 has a predetermined temperature.

(Substrate processing step: S102)

When the temperature of the wafer 200 located at the wafer processing position reaches a predetermined temperature, then the substrate processing step (S102) is performed. In the substrate processing step (S102), while keeping the wafer 200 heated to a predetermined temperature, the first gas supply part 243 is controlled to supply the first processing gas to the process chamber 201, the exhaust part is controlled to evacuate the process chamber 201, and the wafer 200 is processed. At this time, the second gas supply part 244 is controlled either to perform a CVD process by allowing the second processing gas to be present in the processing space together with the first processing gas, or to perform a cyclic process by alternately supplying the first processing gas and the second processing gas. When the process is performed by converting the second processing gas into a plasma state, plasma may be generated in the process chamber 201 by supplying high-frequency power to the distribution plate 234b.

The following method is conceivable as the cyclic process which is one specific example of the film processing method. For example, there may be a case where a DCS gas is used as the first processing gas and an NH₃ gas is used as the second processing gas. In that case, the DCS gas is supplied to the wafer 200 in the first step, and the NH₃ gas is supplied to the wafer 200 in the second step. Between the first step and the second step, a purging step is performed in which an N₂ gas is supplied and the atmosphere in the process chamber 201 is exhausted. A silicon nitride (SiN) film is formed on the wafer 200 by performing a cyclic process in which the first step, the purging step and the second step are performed multiple times.

### (Substrate Loading/Unloading Process: S103)

After the wafer 200 is subjected to the predetermined process, the processed wafer 200 is unloaded from the processing container 202 of the substrate processing module 2000 in the substrate loading/unloading step (S103). The processed wafer 200 is unloaded through the use of, for example, an arm 2900 of the vacuum transfer robot 2700 in the TM 2400.

At this time, for example, when the unprocessed wafer 200 is held by an arm 2800 of the vacuum transfer robot 2700, the vacuum transfer robot 2700 loads the unprocessed wafer 200 into the processing container 202. Then, the substrate processing step (S102) is performed on the wafer 200 in the processing container 202. When the unprocessed wafer 200 is not held by the arm 2800, only the unloading of the processed wafer 200 is performed.

After the vacuum transfer robot 2700 unloads the wafer 200, the unloaded processed wafer 200 is accommodated in the pod 2001 on the IO stage 2100. The accommodation of the wafer 200 in the pod 2001 is performed through the use of the atmosphere transfer robot 2220 in the atmosphere transfer chamber 2200.

### (Determination Process: S104)

In the substrate processing apparatus 100, the substrate processing step (S102) and the substrate loading/unloading step (S103) are repeated until there are no unprocessed wafers 200. When there are no unprocessed wafers 200, the series of processes (S101 to S104) described above comes to an end.

### (5) Procedure Before Execution of Interruption Program

The series of processes described above is controlled by the controller 260. However, the processing program 3200 stored in the memory device 2603 may be infected with a virus from another substrate processing apparatus, an external recording medium or the like via the network 269. In the case where the execution of the processing program 3200 infected with the virus is continued, the substrate processing apparatus 280 is operated in an abnormal state and the wafer 200 and the like are wasted. As a result, the substrate processing throughput is reduced. Therefore, when the processing program 3200 is infected with the virus, the execution of an interruption program 3300 is started to interrupt the execution of the processing program 3200, thereby reducing the waste of the wafer 200 and the like. As a result, it is possible to improve the substrate processing throughput. The term “abnormal state” means a state which is not normal. Specifically, for example, the abnormal state means that the temperature in the process chamber 201 becomes higher than an expected temperature. Furthermore, for example, the abnormal state means that the pressure in the process chamber 201 becomes equal to or higher than the atmospheric pressure.

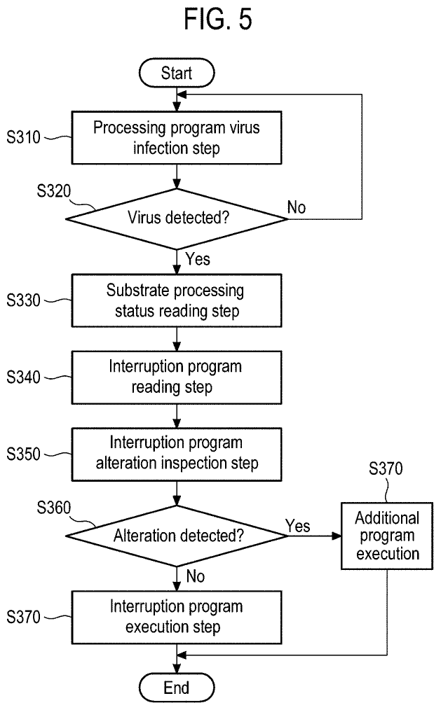

FIG. 5 is a flowchart up to the execution of the interruption program 3300 according to the present embodiment.

### (Processing Program Virus Inspection Step: S310)

In the processing program virus inspection step (S310), whether the processing program 3200 stored in the memory device 2603 is infected with the virus or not is inspected. As used herein, the expression “whether the processing program 3200 is infected with the virus is inspected” means to inspect whether the processing program 3200 has been overwritten with malicious information by a malicious third party. Specifically, the CPU 2601 executes virus detection software (not shown) installed in the memory device 2603 every predetermined time (e.g., 1 second). Thus, the CPU 2601 functions as the virus inspection/determination part 3100, and checks whether the virus is detected from the processing program 3200. A plurality of processing programs 3200 is stored in the memory device 2603. All the processing programs 3200 are inspected for the virus in the virus inspection step (S310). Generally known virus detection software may be used as the virus detection software.

### (Virus Infection Determination Step: S320)

In the virus infection determination step (S320), it is determined whether the processing program 3200 is infected with the virus. Specifically, when the virus is detected in the processing program virus inspection step (S310), the virus inspection/determination part 3100 determines that the processing program 3200 is infected with the virus. In the case where no virus is detected, the virus inspection/determination part 3100 determines that the processing program 3200 is not infected with the virus. In the case where it is determined that the processing program 3200 is infected with the virus, the flow proceeds to a substrate processing status reading step (S330). In the case where it is determined that the processing program 3200 is not infected with the virus, the flow returns to the processing program virus inspection step (S310) to perform the virus inspection step (S310) again.

### (Substrate Processing Status Reading Step: S330)

In the substrate processing status reading step (S330), the processing status of the wafer 200 when the processing program 3200 is determined to be infected with the virus is recognized. As used herein, the expression “the processing status of the wafer 200” refers to the step in which the wafer 200 is processed, and includes any step before, during or after the above-described substrate processing step. Specifically, when it is determined in the virus infection determination step (S320) that the processing program 3200 is infected with the virus, the CPU 2601 recognizes the processing status of the wafer 200 at the time of determination by reading the information on the processing status of the wafer 200 written in the RAM 2602 (for example, flag information that specifies the operating state of the substrate processing apparatus 280). Furthermore, during the execution of the substrate processing step, the CPU 2601 recognizes the processing status of the wafer 200 in more detail by reading whether the process performed on the wafer 200 is being performed in any one of the substrate loading/heating step (S101), the substrate processing step (S102), the substrate loading/unloading step (S103) and the like.

### (Interruption Program Reading Step: S340)

In the interruption program reading step (S340), the interruption program 3300 corresponding to the read processing status of the wafer 200 is read from the memory device 2603. As used herein, the expression “the interruption program corresponding to the processing status of the wafer 200” refers to an interruption program which is defined in advance for each processing status of the wafer 200. Specifically, when the processing status of the wafer 200 is read, the CPU 2601 reads the corresponding interruption program 3300 by referring to a correspondence table (not shown) between the processing statuses of the wafer 200 and the interruption programs 3300, which is stored in the memory device 2603. In the present embodiment, plural types of interruption programs 3300 are stored in the memory device 2603. Among the plural types of interruption programs 3300, the interruption program 3300 corresponding to the processing status of the wafer 200 is read. Details of reading the interruption program 3300 corresponding to the processing status of the wafer 200 will be described below.

### (Interruption Program Alteration Inspection Step: S350)

In the interruption program alteration inspection step (S350), it is inspected whether the read interruption program 3300 has been altered. As used herein, the term “alteration” of the interruption program means that a size capacity (file size) of the read interruption program 3300 has been changed. Specifically, whether the interruption program is altered or not is inspected by comparing the file size of the read interruption program 3300 with the file size corresponding to the read interruption program 3300, which is stored in the memory device 2603 in advance. As a procedure, first, the CPU 2601 checks the file size of the read interruption program 3300. Next, the file size corresponding to the read interruption program 3300 is read by referring to a correspondence table (not shown) between the types of the interruption programs 3300 and the file sizes corresponding to the types of the interruption programs 3300, which is stored in the memory device 2603 in advance. Then, as for the read interruption program 3300, a result of checking the file size is compared with the file size stored in the correspondence table to inspect whether they are equal to each other or not.

### (Alteration Determination Step: S360)

In the alteration determination step (S360), it is determined whether or not the read interruption program has been altered. Specifically, in the interruption program alteration inspection step (S350), in the case where the result of checking the file size of the interruption program 3300 is equal to the file size stored in the correspondence table, it is determined that the interruption program 3300 has not been altered. In the case where they are not equal to each other, it is determined that the interruption program 3300 has been altered. In the case where it is determined that the interruption program 3300 has not been altered, the flow proceeds to an interruption program execution step (S370). Details of the interruption program 3300 will be described below. In the case where it is determined that the interruption program 3300 has been altered, the flow proceeds to another program execution step (S380). Details of another program will be described below. By performing the series of processes (S310 to S360) described above, the procedure before the interruption program is executed comes to an end.

### (6) Interruption Program Execution Step (S370)

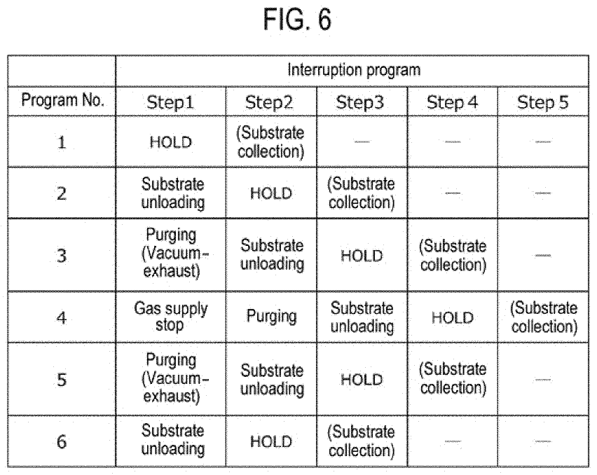

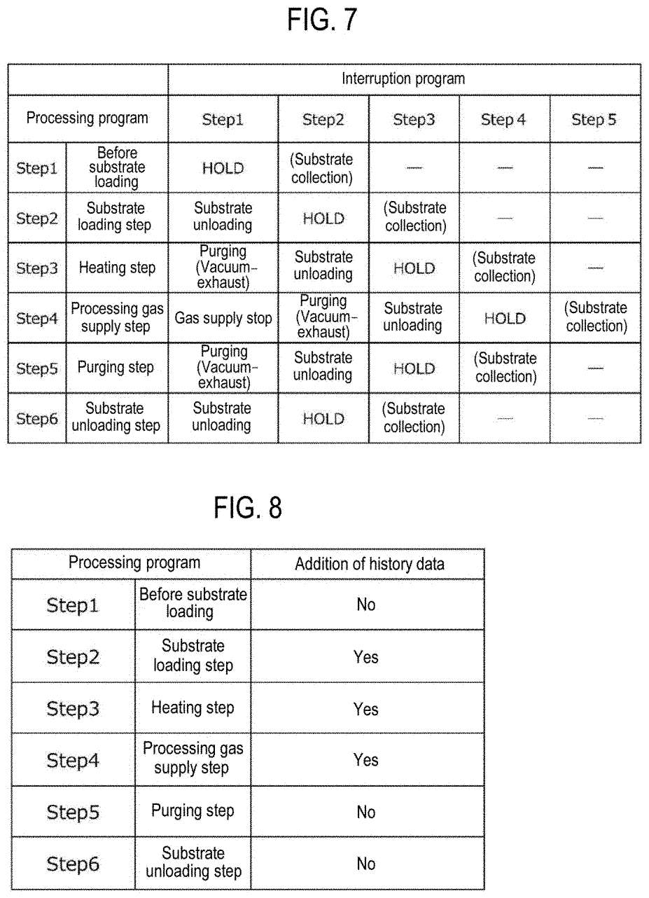

Next, the interruption program execution step (S370) which is executed when it is determined in the alteration determination step (S360) that the interruption program 3300 has not been altered will be described with reference to FIGS. 6 and 7.

If the execution of the processing program 3200 infected with the virus is continued, for example, the inside of the process chamber 201 may reach an unexpectedly high temperature, which may damage the inside of the process chamber 201 and may lead to failure of the substrate processing apparatus 280. As a result, safety of the substrate processing apparatus 280 may be adversely affected. Further, in the case where the execution of the processing program 3200 infected with a virus is continued, for example, the processing on the wafer 200 cannot be performed normally, and the wafer 200 subjected to such processing may be discarded. As a result, the substrate processing throughput may be adversely affected.

It is required that the execution of the processing program 3200 infected with the virus be stopped by executing the interruption program 3300 to avoid the aforementioned situations. Further, it is required that the operation of the substrate processing apparatus 280 be normally stopped by executing the interruption program 3300 instead of the processing program 3200.

At this time, it is necessary to execute the step according to the processing status of the wafer 200 when the processing program 3200 is determined to be infected with a virus, instead of stopping the operation of the substrate processing apparatus 280 on an emergency basis, to stop the operation of the substrate processing apparatus 280 normally. For example, in the case where the processing status of the wafer 200 when the processing program 3200 is determined to be infected with the virus is that before the substrate loading step, for example, the heaters 213a and 213b are stopped, the wafer 200 is collected, and then the operation of the substrate processing apparatus 280 is stopped. On the other hand, in the case where the processing status of the wafer 200 when the processing program 3200 is determined to be infected with the virus is that after the substrate loading step, it is necessary to stop the operation of the substrate processing apparatus 280 at least after further executing the step of unloading the wafer 200 in the process chamber 201 to the outside of the process chamber 201. This is because, in the case where the operation of the substrate processing apparatus 280 is stopped with the wafer 200 remaining in the process chamber 201, the wafer 200 may be an obstacle when re-operating the substrate processing apparatus 280.

In this way, the interruption program 3300 stops the execution of the virus-infected processing program 3200, executes the step according to the processing status of the wafer 200, and stops the operation of the substrate processing apparatus 280, whereby the substrate processing apparatus 280 can be re-operated normally.

In consideration of the above, the memory device 2603 stores, for example, six types of interruption programs 3300, as shown in FIG. 6. For example, the interruption programs 3300 are six types including Program No. 1 to Program No. 6. These interruption programs 3300 respectively include different steps, and can appropriately cope with the processing status of the wafer 200. That is, the operation (step) to be performed after stopping the execution of the processing program 3200 is determined according to the interruption program 3300. Further, the memory device 2603 stores a correspondence table (not shown) in which the processing statuses of the wafer 200 when the processing program 3200 is determined to be infected with the virus are associated with the interruption programs 3300 executed according to the processing statuses. When the processing program 3200 is determined to be infected with the virus, the CPU 2601 selects and reads the corresponding interruption program 3300 with reference to the correspondence table, and then executes the selected interruption program 3300.

The interruption program 3300 executed according to the processing status of the wafer 200 when the processing program 3200 is determined to be infected with the virus will be specifically described below.

If the processing status of the wafer 200 when the processing program 3200 is determined to be infected with the virus is that before the execution of the substrate processing step described above, the interruption program of Program No. 1 is executed. The interruption program 3300 of Program No. 1 includes two steps including HOLD (Step 1) and substrate collection (Step 2) (see FIGS. 6 and 7). As used herein, the term “HOLD” means at least stopping the operation of the heaters 213a and 213b. Hereinafter, the term “HOLD” has such a meaning unless otherwise defined. As described above, when the processing program 3200 is determined to be infected with a virus, the operation of the heaters 213a and 213b is immediately stopped and the wafer 200 is collected. This makes it possible to prevent the virus-infected processing program 3200 from being executed with respect to the wafer 200 in advance. By doing so, it is possible to minimize damage to the substrate processing apparatus 280 and the wafer 200. In addition, it is possible to normally re-operate the substrate processing apparatus 280.

If the processing status of the wafer 200 when the processing program 3200 is determined to be infected with a virus is that during the execution of the substrate loading step which is the former half of the substrate loading/heating step (S101) of the substrate processing process, the interruption program of Program No. 2 is executed. The interruption program 3300 of Program No. 2 includes three steps including substrate unloading (Step 1), HOLD (Step 2) and substrate collection (Step 3) (see FIGS. 6 and 7). As described above, when the processing program 3200 is determined to be infected with the virus, the wafer 200 is immediately unloaded out of the process chamber 201. This makes it possible to prevent the virus-infected processing program 3200 from being executed with respect to the wafer 200 in advance. Then, the operation of the heaters 213a and 213b is stopped (Step 2) and the wafer 200 is collected (Step 3). By doing so, it is possible to minimize damage to the substrate processing apparatus 280 and the wafer 200. In addition, it is possible to normally re-operate the substrate processing apparatus 280.

If the processing status of the wafer 200 when the processing program 3200 is determined to be infected with the virus is that during the execution of the heating step which is the latter half of the substrate loading/heating step (S101) of the substrate processing process, the interruption program 3300 of Program No. 3 is executed. The interruption program 3300 of Program No. 3 includes four steps including purging (Step 1), substrate unloading (Step 2), HOLD (Step 3) and substrate collection (Step 4) (see FIGS. 6 and 7). In the heating step, the inside of the process chamber 201 is kept in a high temperature state. Therefore, when the processing program 3200 is determined to be infected with a virus, the purging step is first performed to evacuate the process chamber 201, thereby lowering the pressure and temperature in the process chamber 201 (Step 1). Then, when the temperature of the wafer 200 reaches a temperature at which the wafer 200 can be unloaded, the wafer 200 is unloaded out of the process chamber 201 (Step 2). By doing so, it is possible to prevent deformation of the wafer 200 due to a rapid temperature change. Then, the operation of the heaters 213a and 213b is stopped (Step 3) and the wafer 200 is collected (Step 4). By doing so, it is possible to minimize damage to the substrate processing apparatus 280 and the wafer 200. In addition, it is possible to normally re-operate the substrate processing apparatus 280.

If the processing status of the wafer 200 when the processing program 3200 is determined to be infected with the virus is that during the execution of the processing gas supply step which is the former half of the substrate processing step (S102), the interruption program 3300 of Program No. 4 is executed. The interruption program of Program No. 4 includes five steps including gas supply stop (Step 1), purging (Step 2), substrate unloading (Step 3), HOLD (Step 4) and substrate collection (Step 5) (see FIGS. 6 and 7). When the processing program 3200 is determined to be infected with the virus as described above, the supply of the processing gas is immediately stopped (Step 1). By doing so, it is possible to prevent the virus-infected processing program 3200 from being continuously executed with respect to the wafer 200. Thereafter, just like the interruption program 3300 of Program No. 3, the steps of purging (Step 2), substrate unloading (Step 3), HOLD (Step 4) and substrate collection (Step 5) are executed. By doing so, it is possible to minimize damage to the substrate processing apparatus 280 and the wafer 200. In addition, it is possible to normally re-operate the substrate processing apparatus 280.

If the processing status of the wafer 200 when the processing program 3200 is determined to be infected with the virus is that during the execution of the purging step which is the latter half of the substrate processing step (S102), the interruption program 3300 of Program No. 5 is executed. The interruption program 3300 of Program No. 5 includes four steps including purging (Step 1), substrate unloading (Step 2), HOLD (Step 3) and substrate collection (Step 4) (see FIGS. 6 and 7). When the processing program 3200 is determined to be infected with the virus as described above, the purging step is continuously executed to vacuum-evacuate the process chamber 201 (Step 1). By doing so, the pressure in the process chamber 201 can be returned to a normal state. Thereafter, the steps of substrate unloading (Step 2), HOLD (Step 3) and substrate collection (Step 4) are executed. By doing so, it is possible to minimize damage to the substrate processing apparatus 280 and the wafer 200. In addition, it is possible to normally re-operate the substrate processing apparatus 280.

If the processing status of the wafer 200 when the processing program 3200 is determined to be infected with the virus is that during the execution of the substrate loading/unloading step (S103), the interruption program 3300 of Program No. 6 is executed. The interruption program 3300 of Program No. 6 includes three steps including substrate unloading (Step 1), HOLD (Step 2) and substrate collection (Step 3) (see FIGS. 6 and 7). When the processing program 3200 is determined to be infected with the virus as described above, the unloading step is continuously performed to unload the wafer 200 out of the process chamber 201 (Step 1). By doing so, it is possible to avoid further execution of the virus-infected processing program 3200 with respect to the wafer 200. Thereafter, the steps of HOLD (Step 2) and substrate collection (Step 3) are executed. By doing so, it is possible to minimize damage to the substrate processing apparatus 280 and the wafer 200. In addition, it is possible to normally re-operate the substrate processing apparatus 280.

After the interruption program 3300 is executed as described above, the inside of the process chamber 201 comes into a clear state in which the processing gas and the wafer 200 are not present. Thus, when the virus is removed and the substrate processing apparatus 280 is re-operated, neither the processing gas nor the wafer 200 remains in the process chamber 201. This makes it possible to immediately start the processing on the wafer 200.

When the substrate processing apparatus 280 is re-operated and the processing on the wafer 200 is restarted, the wafer 200 collected by executing the interruption program 3300 may be reused in some cases. For example, in the case where the wafer 200 is collected before being heated, it can be reused.

Therefore, the history data of the wafer 200 may be added to the substrate data of the wafer 200 whose processing has been interrupted by the execution of the interrupt program 3300. As used herein, the term “history data of the wafer 200” refers to the data relating to the process performed on the wafer 200. Specifically, for example, the history data of the wafer 200 is the data indicating that the heating process for the wafer 200 has already been performed when the interruption program 3300 is executed. The history data added to the substrate data may be used as one of the determination materials for determining whether or not the wafer 200 can be reused. Whether or not the history data of the wafer 200 is added will be described below.

As shown in FIG. 8, the wafer 200 for which the interruption program 3300 has been executed before the execution of the substrate loading step (S101) is collected before being heated. Therefore, there is no addition of the history data of the wafer 200 (see Step 1).

Furthermore, the wafer 200 for which the interruption program 3300 has been executed during the execution of the substrate loading step which is the former half of the substrate loading/heating step (S101) of the substrate processing process is divided into the following two. That is, in the case where the wafer 200 is mounted on the substrate mounting stand 212 when the interruption program 3300 is executed, the history data of the wafer 200 is added. On the other hand, in the case where the wafer 200 is not mounted on the substrate mounting stand 212 when the interruption program 3300 is executed, the history data of the wafer 200 is not added. This is because the substrate mounting stand 212 has been heated to the processing temperature and, therefore, the heating is performed at the moment when the wafer 200 is mounted on the substrate mounting stand 212. For the sake of convenience, an example in which the history data of the wafer 200 is added is shown in Step 2 of FIG. 8.

Furthermore, the wafer 200 for which the interruption program 3300 has been executed during the execution of the heating step which is the latter half of the substrate loading/heating step (S101) of the substrate processing process is collected after the heating is performed. Therefore, the history data of the wafer 200 is added (see Step 3). The same applies to the wafer 200 for which the interruption program 3300 has been executed during the execution of the processing gas supply step which is the former half of the substrate processing step (S102) (see Step 4).

The wafer 200 for which the interruption program 3300 has been executed during the execution of the purging step (Step 5) which is the latter half of the substrate processing step (S102) has already undergone the film-forming process and does not require addition of history data. Therefore, there is no addition of the history data (see Step 5). The same applies to the wafer 200 for which the interruption program 3300 has been executed during the execution of the substrate loading/unloading step (S103) (see Step 6).

### (7) Additional Program Execution Step (S380)

Next, additional program execution step (S380) executed when the interruption program 3300 is determined to be altered in the alteration determination step (S360) shown in FIG. 5 will be described.

The term “additional program” refers to a backup program for the altered interruption program 3300. Alternatively, the additional program may be an alternative program for the altered interruption program 3300 among the plural types of interruption programs 3300.

The backup program for the altered interruption program 3300 is an interruption program 3300 which is backed up in a predetermined memory device in advance and configured to reproduce the interruption program 3300 available before alteration. In addition to the memory device 2603, any storage medium can be used as the “predetermined memory device” as long as the CPU 2601 can access the storage medium. Further, the alternative program for the altered interruption program 3300 is, for example, the interruption program 3300 including steps which cause damage to the substrate processing apparatus 280 or the wafer 200 less than that caused by the steps of the altered interruption program 3300. For example, when the interruption program 3300 of Program No. 3 is altered, the interruption program 3300 of Program No. 4 may be used as the alternative program.

By executing the backup program or the alternative program, the execution of the processing program 3200 infected with the virus can be stopped even when the interruption program 3300 to be executed has been altered. Further, by safely stopping the operation of the substrate processing apparatus 280, it is possible to normally re-operate the substrate processing apparatus 280.

### (8) Effects of the Present Embodiment

According to the present embodiment, one or more of the following effects may be obtained.

(a) In the present embodiment, the controller 260 inspects whether the processing program 3200 is infected with the computer virus or not. In the case where the processing program 3200 is determined to be infected with the computer virus, the controller 260 reads and executes the interruption program 3300. Since the interruption program 3300 interrupts the execution of the virus-infected processing program 3200 in this way, it is possible to prevent the substrate processing apparatus 280 from being operated in an abnormal state and to avoid waste of the wafer 200. As a result, it is possible to improve a throughput in substrate processing.

(b) In the present embodiment, the controller 260 is configured to determine the operation after the stop of execution of the processing program 3200 according to the interruption program 3300. When the processing program 3200 is infected with a virus as described above, the operation of the substrate processing apparatus 280 is not stopped on an emergency basis, but the interruption program 3300 associated in advance according to the processing status of the wafer 200 is executed. The operation of the substrate processing apparatus 280 is normally stopped by executing the step according to the processing status of the wafer 200. Therefore, it is possible to minimize the damage to the substrate processing apparatus 280 and the wafer 200, to ensure the safety of the substrate processing apparatus 280, and to improve the throughput in substrate processing.

(c) In the present embodiment, when the processing program 3200 under execution is determined to be infected with the computer virus, the interruption program 3300 is executed instead of the processing program 3200 under execution. In this way, the processing program 3200 infected with the virus is immediately switched to the interruption program 3300, whereby damage to the substrate processing apparatus 280 and the wafer 200 can be minimized.

(d) In the present embodiment, the memory device 2603 stores plural types of interruption programs 3300. The controller 260 selects an interruption program 3300 according to the processing status of the wafer 200 from the plural types of interruption programs 3300, and reads and executes the selected interruption program 3300. Therefore, the controller 260 can select the interruption program 3300 most suitable for minimizing the damage to the substrate processing apparatus 280 and the wafer 200 from the plural types of interruption programs 3300 and can execute the selected interruption program 3300. Furthermore, by selecting and executing the most suitable interruption program 3300, it is possible to shorten the time required for returning the substrate processing apparatus 280 to a normal state.

(e) In the present embodiment, the controller 260 inspects alteration of the interruption program 3300 when reading the interruption program 3300 from the memory device 2603. Therefore, for example, it is possible to avoid execution of the interruption program 3300 that may be infected by the computer virus.

(f) In the present embodiment, when the controller 260 detects alteration of the interruption program 3300, the controller 260 reads and executes the backup program for the altered interruption program 3300. Alternatively, the controller 260 reads and executes the alternative program for the altered interruption program. Therefore, even when the interruption program 3300 to be executed is altered, the execution of the processing program 3200 infected with the virus can be stopped by executing the backup program or the alternative program. Further, by safely stopping the operation of the substrate processing apparatus 280, it is possible to normally re-operate the substrate processing apparatus 280.

(g) In this embodiment, the controller 260 adds the history data of the wafer 200 to the wafer 200 whose processing has been interrupted by the interruption program 3300. By adding the history data of the wafer 200 in this way, the history data can be used as one of the determination materials when determining a reusable wafer 200. As a result, it is possible to reduce the waste of the wafers 200 and improve the throughput in substrate processing.

### OTHER EMBODIMENTS

Although one embodiment of the present disclosure has been specifically described above, the present disclosure is not limited to the above-described embodiments. Various modifications may be made without departing from the spirit thereof.

For example, as the method of inspecting alteration of the interruption program 3300, the method of checking the file size has been described by way of example. However, the present disclosure is not limited thereto. For example, alteration of the interruption program 3300 may be checked by a known method using a hash tag.

Further, in the above-described embodiments, in the step of stopping the heaters 213a and 213b, the same temperature as the temperature of the heaters 213a and 213b in the idle state of the substrate processing apparatus may be maintained without completely stopping the heaters 213a and 213b. With this configuration, it is possible to prevent the substrate processing apparatus from being completely cooled. Furthermore, it is possible to shorten a heating time and to reduce a downtime from stop to restoration of the substrate processing apparatus.

Further, in the above-described embodiments, the method of alternately supplying the first processing gas and the second processing gas to form the film has been described. However, other methods may be used. For example, the process may use one type of gas instead of two types of gases, or may use three or more types of gases.

Further, in the above-described embodiments, there has been described the example in which the SiN film is formed on the wafer surface by using the DCS gas, which is the silicon-containing gas as the precursor gas and the NH₃ gas, which is the nitrogen-containing gas as the reaction gas. However, the present disclosure is also applicable to film formation using other gases. Examples of other films include an oxygen-containing film, a nitrogen-containing film, a carbon-containing film, a boron-containing film, a metal-containing film, and films containing a plurality of these elements. Specific examples of these films include an AlO film, a ZrO film, an HfO film, an HfAlO film, a ZrAlO film, an SiC film, an SiCN film, an SiBN film, a TiN film, a TiC film, and a TiAlC film.

Further, in the above-described embodiments, the film-forming process is given as an example of the process performed in the substrate processing step. However, the present disclosure is not limited thereto. That is, the present disclosure may be applied to processes other than the film-forming process described as the example in the above-described embodiments. Examples of other processes include a diffusion process using plasma, an oxidizing process, a nitriding process, an oxynitriding process, a reducing process, an oxidizing/reducing process, an etching process, a heating process, and the like. Further, for example, the present disclosure may be applied to the case where the surface of the substrate or the film formed on the substrate is subjected to a plasma oxidizing process or a plasma nitriding process using only the reaction gas. Further, the present disclosure may be applied to a plasma annealing process using only the reaction gas. These processes may be performed as the first process, and then the second process described above may be performed.

Further, in the above-described embodiments, there is shown the case where the substrate processing module 2000 that performs the substrate processing process is configured as the single-wafer-type substrate processing apparatus, that is, an apparatus configuration in which one wafer 200 is processed in one process chamber 201. However, the present disclosure is not limited thereto, and may be applied to an apparatus where a plurality of substrates is arranged in a horizontal direction or a vertical direction.

Further, for example, in the above-described embodiments, the semiconductor device manufacturing process has been described. However, the present disclosure may be applied to processes other than the semiconductor device manufacturing process. Examples of other processes include substrate processing processes such as a liquid crystal device manufacturing process, a solar cell manufacturing process, a light emitting device manufacturing process, a glass substrate processing process, a ceramic substrate processing process, a conductive substrate processing process, and the like.

### Aspects of Present Disclosure

Hereinafter, some aspects of the present disclosure will be additionally described as supplementary notes.

### (Supplementary Note 1)

According to an aspect of the present disclosure, there is provided a substrate processing apparatus, comprising:

a processing part configured to process a substrate;

a memory part configured to store a processing program configured to process the substrate and an interruption program configured to interrupt execution of the processing program; and

a control part configured to control the processing part by reading and executing the processing program,

wherein the control part is configured to inspect whether the processing program is infected with a computer virus, and read and execute the interruption program when the processing program is determined to be infected with the computer virus.

### (Supplementary Note 2)

In the apparatus of Supplementary Note 1, the control part may be configured to determine an operation after stop of execution of the processing program according to the interruption program.

### (Supplementary Note 3)

In the apparatus of Supplementary Note 1 or 2, the control part may be configured to execute the interruption program instead of the processing program under execution when the processing program under execution is determined to be infected with the computer virus.

### (Supplementary Note 4)

In the apparatus of any one of Supplementary Notes 1 to 3, the memory part may be configured to store plural types of interruption programs.

### (Supplementary Note 5)

In the apparatus of Supplementary Note 4, preferably, the control part may be configured to select an interruption program among the plural types of interruption programs according to a processing status of the substrate, to read the selected interruption program from the memory part, and to execute the read interruption program.

### (Supplementary Note 6)

In the apparatus of any one of Supplementary Notes 1 to 5, the control part may be configured to inspect alteration of the interruption program when reading the interruption program from the memory part.

### (Supplementary Note 7)

In the apparatus of Supplementary Note 6, the control part may be configured to read and execute a backup program for the altered interruption program when the alteration of the interruption program is detected.

### (Supplementary Note 8)

In the apparatus of Supplementary Note 6, the control part may be configured to read an alternative program for the altered interruption program among plural types of interruption programs and to execute the alternative program when the alteration of the interruption program is detected.

### (Supplementary Note 9)

In the apparatus of any one of Supplementary Notes 1 to 8, the control part may be configured to add history data of the substrate to the substrate for which substrate processing is interrupted by the interruption program.

### (Supplementary Note 10)

According to another aspect of the present disclosure, there is provided a method of manufacturing a semiconductor device, comprising:

processing a substrate by executing a processing program stored in a memory part;

inspecting and determining whether the processing program is infected with a computer virus; and

executing an interruption program stored in the memory part and configured to interrupt the processing program, when the processing program is determined to be infected with the computer virus.

### (Supplementary Note 11)

According to another aspect of the present disclosure, there is provided a program that causes, by a computer, a substrate processing apparatus to perform a process, comprising:

processing a substrate by executing a processing program stored in a memory part;

inspecting and determining whether the processing program is infected with a computer virus; and

executing an interruption program stored in the memory part and configured to interrupt the processing program, when the processing program is determined to be infected with the computer virus.

According to the present disclosure in some embodiments, it is possible to improve a throughput in substrate processing.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

1. A method of manufacturing a semiconductor device, comprising:
(a) processing a substrate by executing a processing program stored in a memory;
(b) inspecting and determining whether the processing program is infected with a computer virus;
(c) recognizing a processing status of the substrate at a timing of determining that the processing program is infected with the computer virus; and
(d) executing at least one interruption program that corresponds to the processing status of the substrate and is configured to interrupt the processing program at a step of processing the substrate corresponding to the processing status of the substrate.

2. The method of claim 1, wherein when it is determined in (b) that the processing program under execution is infected with the computer virus, the at least one interruption program is executed in (d) instead of the processing program under execution.

3. The method of claim 1, wherein the at least one interruption program includes plural types of interruption programs, and
wherein in (d), an interruption program among the plural types of interruption programs is selected according to the processing status of the substrate, and the selected interruption program is read from the memory to be executed.

4. The method of claim 2, wherein the at least one interruption program includes plural types of interruption programs, and
wherein in (d), an interruption program among plural types of interruption programs is selected according to the processing status of the substrate, and the selected interruption program is read from the memory to be executed.

5. The method of claim 1, wherein (d) includes inspecting alteration of the at least one interruption program when the at least one interruption program is read from the memory.

6. The method of claim 2, wherein (d) includes inspecting alteration of the at least one interruption program when the at least one interruption program is read from the memory.

7. The method of claim 3, wherein (d) includes inspecting alteration of the selected interruption program when the selected interruption program is read from the memory.

8. The method of claim 5, further comprising, when the alteration of the at least one interruption program is detected, reading and executing a backup program for the altered interruption program.

9. The method of claim 6, further comprising, when the alteration of the at least one interruption program is detected, reading and executing a backup program for the altered interruption program.

10. The method of claim 7, further comprising, when the alteration of the selected interruption program is detected, reading and executing a backup program for the altered interruption program.

11. The method of claim 5, wherein the at least one interruption program includes plural types of interruption programs, further comprising, when the alteration of the at least one interruption program is detected, reading an alternative program of the altered interruption program among the plural types of interruption programs and executing the read alternative program.

12. The method of claim 6, wherein the at least one interruption program includes plural types of interruption programs, further comprising, when the alteration of the at least one interruption program is detected, reading an alternative program of the altered interruption program among the plural types of interruption programs and executing the read alternative program.

13. The method of claim 7, wherein when the alteration of the selected interruption program is detected, reading an alternative program of the altered interruption program among the plural types of interruption programs and executing the read alternative program.

14. The method of claim 1, further comprising adding history data of the substrate to the substrate for which substrate processing is interrupted by the at least one interruption program.

15. The method of claim 2, further comprising adding history data of the substrate to the substrate for which substrate processing is interrupted by the at least one interruption program.

16. The method of claim 3, further comprising adding history data of the substrate is added to the substrate for which substrate processing is interrupted by the selected interruption program.
